(19) United States
(12) Patent Application Publication
(10) Pub. No.: US 2023/0393416 A1
(43) Pub. Date: Dec. 7, 2023

(54) EYEGLASSES

(71) Applicant: PROHERO GROUP CO., LTD, TAINAN CITY (TW)

(72) Inventor: PEN WEI CHEN, TAINAN CITY (TW)

(21) Appl. No.: 17/805,590

(22) Filed: Jun. 6, 2022

(51) Int. Cl. G02C 7/02

(52) U.S. Cl. CPC G02C 7/02; G02C 2200/06

(57) ABSTRACT

The invention relates to a pair of eyeglasses. The eyeglasses include a frame, a lens, and a movable tenon-like piece. The frame is provided with a mounting slot which is defined by a front wall, a rear wall, and a top wall of the frame and having an opening facing downward. An upper edge of the lens is mounted into the mounting slot. The movable tenon-like piece is inserted through the rear wall and the upper edge of the lens. When the movable tenon-like piece is moved horizontally from an unlocked-and-released position to a locked-and-fixed position, the lens with the upper edge mounted in the mounting slot of the frame is fixed in that state. The assembly of the frame with the lens is completed.

### BACKGROUND OF THE INVENTION

### Field of the Invention

The present invention relates to a pair of eyeglasses, especially to a pair of eyeglasses which includes a movable tenon-like piece able to be moved directly for fixing or releasing a lens mounted in a mounting slot of a frame.

### Description of Related Art

Among glasses available on the market now, some glasses include lenses able to be assembled and disassembled. Thus users can replace the lenses not only according to conditions and occasions but also when the lens is damaged so as to avoid waste of resources, reduce replacement cost, and enhance economic efficiency.

Refer to FIG. 7, a pair of conventional glasses include a frame 10 and a lens 20. The frame 10 consists of an upper circular portion 101, a lower circular portion 102, an upper mounting slot 103 arranged at the upper circular portion 101 for mounting a periphery of an upper part of the lens 20, a first fastener 104 disposed on each of two sides of the upper circular portion 101, a lower mounting slot 105 formed on the lower circular portion 102 for mounting a periphery of a lower part of the lens 20, and a second fastener 106 engaged with the first fastener 104 and disposed on each of two sides of the lower circular portion 102. Thereby the lens 20 is held in the frame 10 by the first and second fasteners 104, 106 engaged with each other, and the periphery of the upper part and the periphery of the lower part of the lens 20 respectively mounted into the upper mounting slot 103 of the upper circular portion 101 and the lower mounting slot 105 of the lower circular portion 102 of the frame 10.

Refer to FIG. 8, a pair of another conventional glasses are disclosed. An eyeglass frame 30 is divided into an upper frame 301, and a lower frame 304 separated from each other. A tenon segment 302 which is extended downward from each of two sides and a middle part of the upper frame 301 is provided with at least two pins 303 on an action surface thereof. A recessed area 305 which is formed on each of two sides and a middle part of the lower frame 304 is provided with a through slot 306 on an action surface thereof and communicating with the through slot 306. The pins 303 on the tenon segment 302 extended from the upper frame 301 can be mounted smoothly and inserted through the through slot 306 of the lower frame 304 while a lens is held in an area defined by the upper frame 301 and the lower frame 304.

In the above two glasses, designs and styles of a lower edge of the lens are limited. Thus there is room for improvement and there is a need to provide a pair of glasses with novel structure.

### SUMMARY OF THE INVENTION

Therefore, it is a primary object of the present invention to provide a pair of eyeglasses which includes a movable tenon-like piece disposed on a surface of a rear wall of a frame close to human face. Thus the movable tenon-like piece will not be exposed for aesthetic purposes while viewing a front side of the frame and higher business value is obtained. Moreover, assembly and disassembly of the eyeglasses are quite convenient, able to be performed easily,

In order to achieve the above objects, a pair of eyeglasses according to the present invention includes a frame, a lens, and a movable tenon-like piece.

The frame is composed of a front wall, a rear wall, a top wall used for connecting the front wall and the rear wall, a mounting slot defined by the front wall, the rear wall, and the top wall and having an opening facing downward, an insertion hole disposed on the rear wall and corresponding to a nasal bridge of a human face, and a recessed hole arranged at a surface of the front wall facing the mounting slot and corresponding to the insertion hole. The insertion hole is communicating with the mounting slot.

A notch which is formed on an upper edge of the lens at a position corresponding to the nasal bridge of the human face and penetrating the lens is composed of an insertion portion with an opening facing upward and a locking portion located at a lower part of the insertion portion and recessed laterally toward a first direction.

The movable tenon-like piece consists of a pull portion, a mounting block projecting from one side thereof away from the user's face, a through hole formed at a middle portion of the mounting block, and a hooklike portion which is extended from the pull portion, corresponding to the through hole and having a free end and a fixed end opposite to the free end. The fixed end is connected to the pull portion. The pull portion is having sectional area in the vertical direction larger than a sectional area of the insertion hole. The hooklike portion further includes a pin and a hook which is located at the free end of the hooklike portion.

The mounting block of the movable tenon-like piece is inserted through the insertion hole, the mounting slot, and mounted into the recessed hole. The hook of the movable tenon-like piece is hooked on an inner surface of the rear wall. Then the upper edge of the lens is mounted into the mounting slot. When the opening on the insertion portion of the lens is aligned with the mounting block of the movable tenon-like piece, the movable tenon-like piece is just at an unlocked-and-released position. Under such state, the lens and the frame can be separated from each other. When the movable tenon-like piece is pulled laterally toward the first direction for allowing the mounting block being inserted into the locking portion, the movable tenon-like piece is at a locked-and-fixed position. Under such state, the lens and the frame are unable to be separated from each other.

Preferably, the rear wall is provided with an unlocking positioning slot and a locking positioning slot respectively corresponding to the unlocked-and-released position and the locked-and-fixed position between which the movable tenon-like piece is switched. The pin is mounted in the unlocking positioning slot when the movable tenon-like piece is moved to the unlocked-and-released position while the pin is engaged in the locking positioning slot when the movable tenon-like piece is moved to the locked-and-fixed position.

Preferably, a surface of the rear wall of the frame facing the user's face and corresponding to the nasal bridge of the human face is provided with a concave area. The insertion hole is located within the concave area and the pull portion is mounted in the concave area.

The present eyeglasses have the following advantages.
1. Only the upper edge of the lens is connected with the frame while the lower edge and lateral edge of the lens are in an open design. This helps changes in the styles of the lens and users can replace the lens with another having different style.
2. While switching between the unlocked-and-released position and the locked-and-fixed position, the movable tenon-like piece will not come off from the lens so that there is no missing part.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an exploded view showing a frame, a lens, and a movable tenon-like piece of an embodiment according to the present invention;

FIG. 2 is a perspective view of an embodiment formed by a frame, a lens, and a movable tenon-like piece assembled with one another according to the present invention;

FIG. 3 is a schematic drawing showing a movable tenon-like piece located at an unlocked-and-released position in an assembly of a frame, a lens and the movable tenon-like piece of the embodiment according to the present invention;

FIG. 4 is a sectional view taken along the line a-a of the embodiment in FIG. 3;

FIG. 5 is a schematic drawing showing a movable tenon-like piece located at a locked-and-fixed position in an assembly of a frame, a lens and the movable tenon-like piece of the embodiment according to the present invention;

FIG. 6 is a sectional view taken along the line b-b of the embodiment in FIG. 5;

FIG. 7 is an exploded view of a prior art;

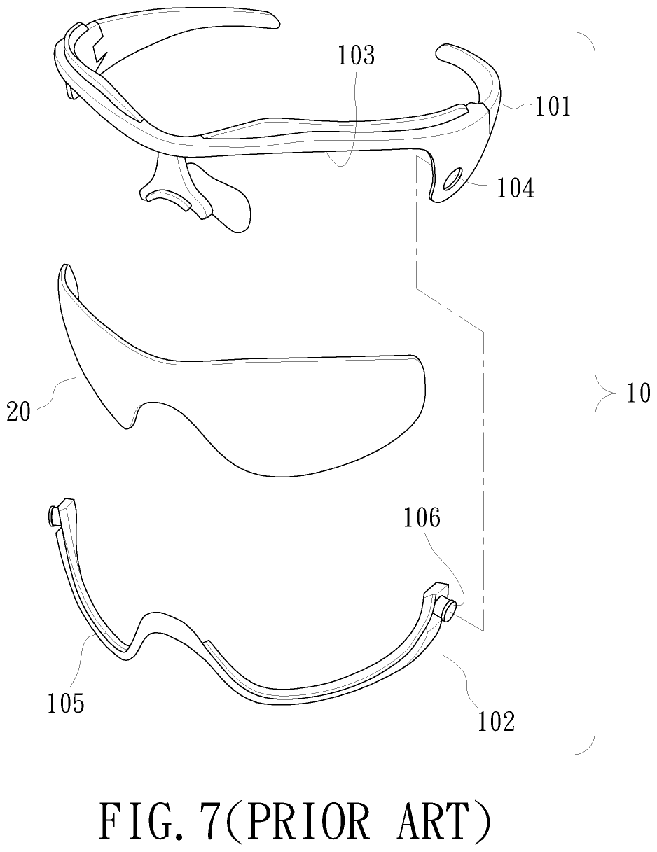

FIG. 8 is a schematic drawing showing another prior art.

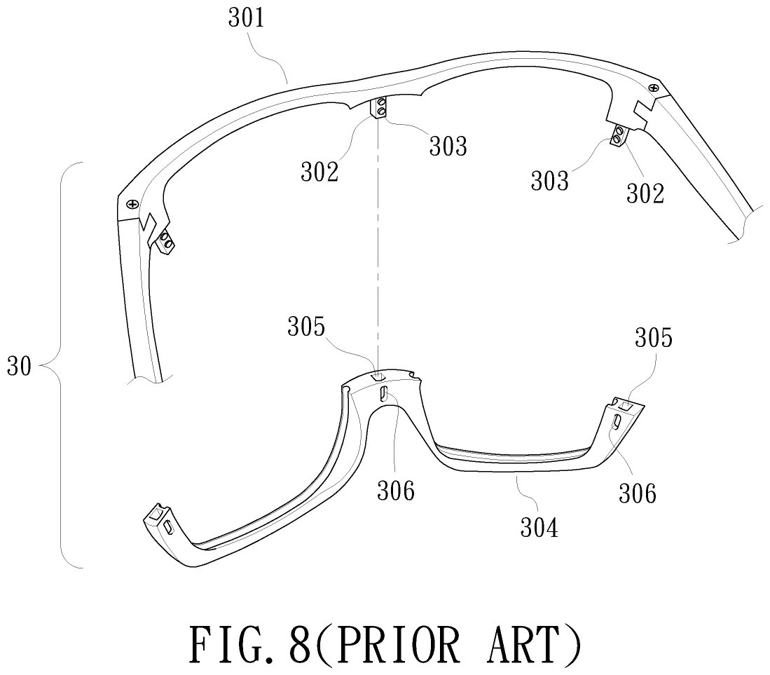

### DETAILED DESCRIPTION OF THE PREFERRED EMBODIMENT

In order to learn technical features and functions of the present invention, please refer to the following embodiments with detailed descriptions, related figures and reference signs.

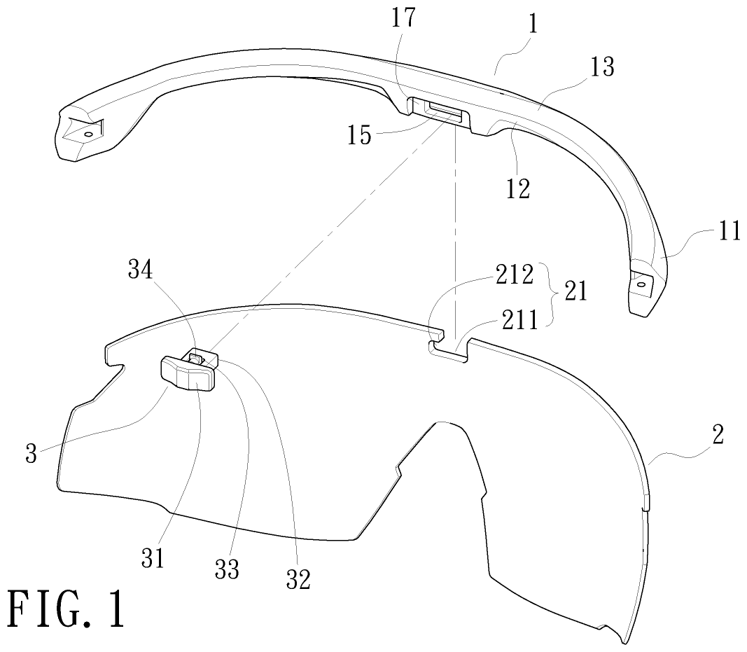

Refer to FIG. 1, a pair of eyeglasses according to the present invention includes a frame 1, a lens 2, and a movable tenon-like piece 3.

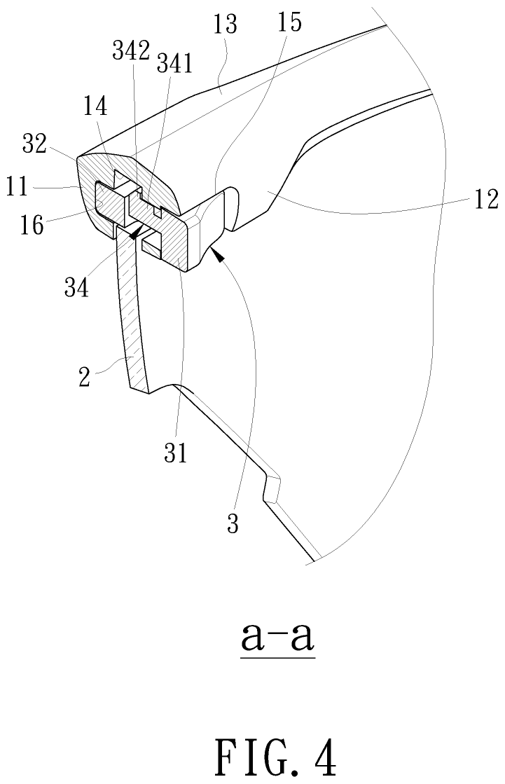

Refer to FIG. 1-4, the frame 1 consists of a front wall 11, a rear wall 12, a top wall 13 used for connecting the front wall 11 and the rear wall 12, a mounting slot 14 defined by the front wall 11, the rear wall 12, and the top wall 13 and having an opening facing downward, an insertion hole 15 disposed on the rear wall 12 and corresponding to a nasal bridge on a human face, and a recessed hole 16 arranged at a surface of the front wall 11 facing the mounting slot 14 and corresponding to the insertion hole 15. Both the insertion hole 15 and the recessed hole 16 are communicating with the mounting slot 14.

A notch 21 is formed on an upper edge of the lens 2 at a position corresponding to the nasal bridge of the human face and composed of an insertion portion 211 with an opening facing upward and a locking portion 212 located at a lower part of the insertion portion 211 and recessed laterally toward a first direction. The upper edge of the lens 2 is mounted into the mounting slot 14 of the frame 1 and the notch 21 of the lens 2 is aligned with both the insertion hole 15 and the recessed hole 16 of the frame 1 under such condition.

The movable tenon-like piece 3 is composed of a pull portion 31, a mounting block 32, a through hole 33, and a hooklike portion 34. The pull portion 31 is having sectional area in the vertical direction larger than a size of the insertion hole 15 so that the movable tenon-like piece 3 will not be fallen into the mounting slot 14 of the frame 1 completely. The mounting block 32 is projecting from one side of the movable tenon-like piece 3 which is away from the user's face and the through hole 33 is formed at the middle portion of the mounting block 32. The hooklike portion 34 is extended from the pull portion 31 of the movable tenon-like piece 3, corresponding to the through hole 33 and having a free end and a fixed end which is opposite to the free end and connected to the pull portion 31. The free end of the hooklike portion 34 is flexible. The hooklike portion 34 consists of a pin 341 and a hook 342 which is located at the free end of the hooklike portion 34. After the mounting block 32 of the movable tenon-like piece 3 being inserted through the insertion hole the mounting slot 14, and then mounted into the recessed hole 16, the movable tenon-like piece 3 can be moved horizontally to be switched between an unlocked-and-released position and a locked-and-fixed position at which the movable tenon-like piece 3 is unlocked or locked respectively.

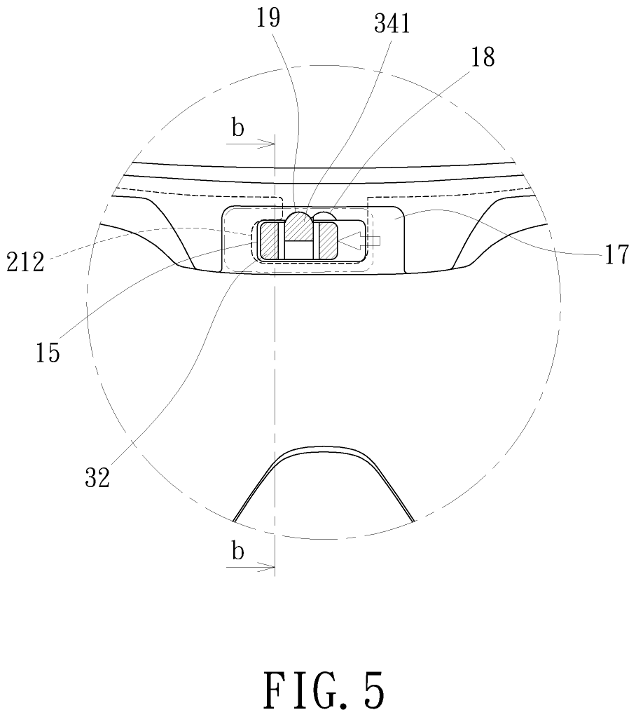

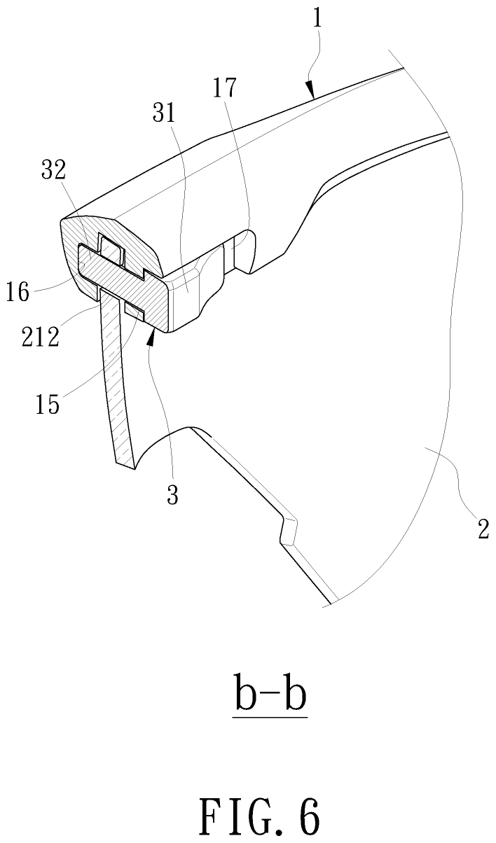

While being assembled, as shown in FIG. 1-6, the mounting block 32 of the movable tenon-like piece 3 is inserted through the insertion hole 15 at the rear wall 12 of the frame 1, the mounting slot 14, and mounted into the recessed hole 16 at the front wall 11. The movable tenon-like piece 3 will not be released from the frame 1 by the hook 342 of the hooklike portion 34 hooked on an inner surface of the rear wall 12 of the frame 1. Then the upper edge of the lens 2 is mounted into the mounting slot 14 of the frame 1 with the notch 21 being aligned with the insertion hole 15. Since the opening on the insertion portion 211 of the notch 21 of the lens 2 aligned with the mounting block 32 of the movable tenon-like piece 3, the upper edge of the lens 2 is mounted into the mounting slot 14 smoothly. At the moment, the movable tenon-like piece 3 is at an unlocked-and-released position to be in an unlocked state at which the lens 2 can be mounted in or removed from the mounting slot 14 of the frame 1. When the movable tenon-like piece 3 is pulled laterally toward the first direction for allowing the mounting block 32 of the movable tenon-like piece 3 being inserted into the locking portion 212 of the lens, the lens 2 is limited in the vertical direction, and unable to be detached from the mounting slot 14 of the frame 1. Now the movable tenon-like piece 3 is at a locked-and-fixed position to be in a locked state.

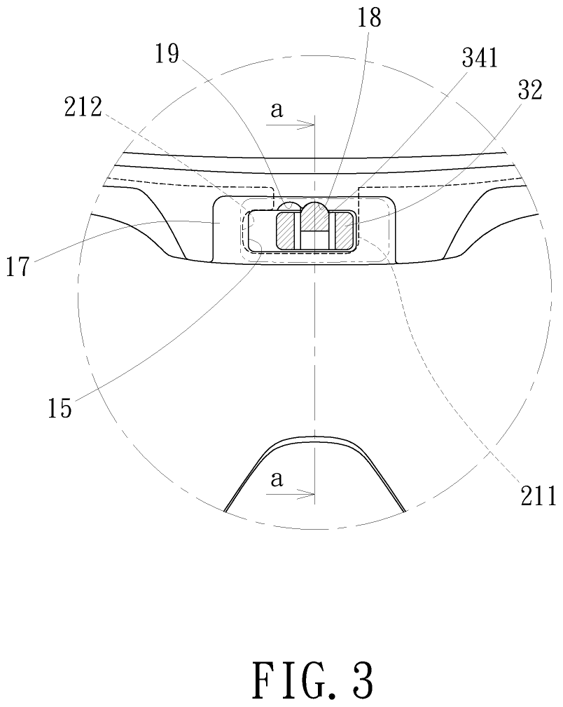

In a preferred embodiment, refer to FIG. 3-6, the rear wall 12 of the frame 1 is provided with an unlocking positioning slot 18 and a locking positioning slot 19 respectively corresponding to the unlocked-and-released position and the locked-and-fixed position between which the movable tenon-like piece 3 is switched. The pin 341 of the movable tenon-like piece 3 is mounted in the unlocking positioning slot 18 when the movable tenon-like piece 3 is moved to the unlocked-and-released position while the pin 341 of the movable tenon-like piece 3 is engaged in the locking positioning slot 19 when the movable tenon-like piece 3 is moved to the locked-and-fixed position. Thereby the movable tenon-like piece 3 at the locked-and-fixed position after being moved toward the first direction will not change its locked state easily.

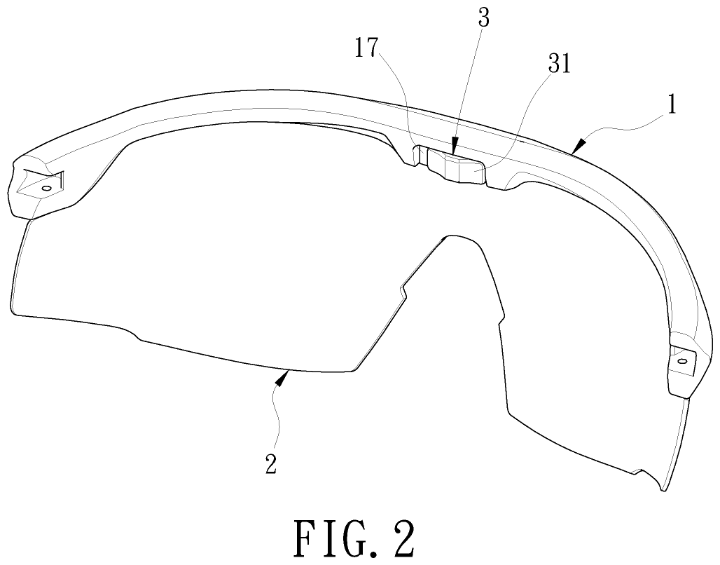

In a preferred embodiment, a surface of the rear wall 12 of the frame 1 facing the user's face and corresponding to the nasal bridge is provided with a concave area 17 (as shown in FIG. 1 and FIG. 2). The insertion hole 15 is located within the concave area 17 and there is just enough room for mounting the pull portion 31 of the movable tenon-like piece 3 in the concave area 17 so that the pull portion 31 of the movable tenon-like piece 3 will not be protruding too much from the concave area 17.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A pair of eyeglasses comprising a frame, a lens and a movable tenon-like piece;
wherein the frame includes a front wall, a rear wall, a top wall used for connecting the front wall and the rear wall, a mounting slot defined by the front wall, the rear wall, and the top wall and having an opening facing downward, an insertion hole disposed on the rear wall and corresponding to a nasal bridge of a human face, and a recessed hole arranged at a surface of the front wall facing the mounting slot and corresponding to the insertion hole; the insertion hole is communicating with the mounting slot;
wherein a notch is formed on an upper edge of the lens corresponding to the nasal bridge of the human face and composed of an insertion portion with an opening facing upward, and a locking portion located at a lower part of the insertion portion and recessed laterally toward a first direction;
wherein the movable tenon-like piece includes a pull portion, a mounting block projecting from one side thereof adjacent to the front wall of the frame, a through hole formed at a middle portion of the mounting block, and a hooklike portion extended from the pull portion and having a free end and a fixed end opposite to the free end;
the fixed end is connected to the pull portion and the pull portion is having a sectional area in a vertical direction larger than a size of the insertion hole; the hooklike portion includes a pin and a hook which is located at the free end of the hooklike portion; wherein the mounting block of the movable tenon-like piece is inserted through the insertion hole, the mounting slot, and mounted into the recessed hole and the hook of the movable tenon-like piece is hooked on an inner surface of the rear wall; the mounting block is able to be moved in the insertion hole and the mounting slot so that the movable tenon-like piece is switched between an unlocked-and-released position and a locked-and-fixed position.

2. The eyeglasses as claimed in claim 1, wherein the rear wall is provided with an unlocking positioning slot and a locking positioning slot respectively corresponding to the unlocked-and-released position and the locked-and-fixed position between which the movable tenon-like piece is switched; the pin is mounted in the unlocking positioning slot when the movable tenon-like piece is moved to the unlocked-and-released position while the pin is mounted in the locking positioning slot when the movable tenon-like piece is moved to the locked-and-fixed position.

3. The eyeglasses as claimed in claim 2, wherein a concave area is arranged at a surface of the rear wall of the frame facing the human face and corresponding to the nasal bridge of the human face; the insertion hole is located within the concave area and the pull portion is mounted in the concave area.

4. The eyeglasses as claimed in claim 1, wherein a concave area is arranged at a surface of the rear wall of the frame facing the human face and corresponding to the nasal bridge of the human face; the insertion hole is located within the concave area and the pull portion is mounted in the concave area.
